(19) United States
(12) Patent Application Publication
(10) Pub. No.: US 2026/0088985 A1
(43) Pub. Date: Mar. 26, 2026

(54) AUTHENTICATED ENCRYPTION DEVICE, AUTHENTICATED ENCRYPTION METHOD, AND COMPUTER READABLE MEDIUM

(71) Applicant: Mitsubishi Electric Corporation, Tokyo (JP)

(72) Inventor: Yusuke NAITO, Tokyo (JP)

(73) Assignee: Mitsubishi Electric Corporation, Tokyo (JP)

(21) Appl. No.: 19/408,823

(22) Filed: Dec. 4, 2025

Related U.S. Application Data
(63) Continuation of application No. PCT/JP2023/027207, filed on Jul. 25, 2023.

(51) Int. Cl. H04L 9/08; H04L 9/06

(52) U.S. Cl. CPC H04L 9/0861; H04L 9/0618

(57) ABSTRACT

An initial processing unit (21) generates a secret value B from a secret key in authenticated encryption. A function F processing unit (22) repeats a process of setting the secret value B generated by the initial processing unit (21) as an input block of a block cipher, and updating the secret value B using the block cipher. A ciphertext processing unit (23) executes at least one of a process of encrypting a plaintext M and a process of decrypting a ciphertext C, using the secret value B updated by the function F processing unit (23).

### CROSS REFERENCE TO RELATED APPLICATION

This application is a Continuation of PCT International Application No. PCT/JP2023/027207, filed on Jul. 25, 2023, which is hereby expressly incorporated by reference into the present application.

### TECHNICAL FIELD

The present disclosure relates to authenticated encryption using a block cipher.

### BACKGROUND ART

An authenticated encryption algorithm is an encryption algorithm that provides both confidentiality and tamper detection functions at the same time. The use of the authenticated encryption algorithm allows two parties to communicate a plaintext between them while maintaining secrecy, and also allows a recipient to check whether a message transmitted through a communication channel has been tampered with.

The authenticated encryption algorithm includes two algorithms: an encryption function Enc and a decryption function Dec.

The encryption function Enc is a function that takes as inputs a secret key K, a nonce N, a header A, and a plaintext M, and outputs a ciphertext C and an authenticator Tag for tamper detection. A different value is used as the nonce N for each encryption, and the same value is never used unless the secret key K is changed.

The decryption function Dec is a function that takes as inputs a secret key K, a nonce N, a header A, a ciphertext C, and an authenticator Tag for tamper detection, and outputs a plaintext M if the input values have not been tampered with, and outputs a value indicating falsification if the input values have been tampered with. In the following, a value indicating falsification will be referred to as reject.

It is assumed that a sender Alice and a recipient Bob communicate using the authenticated encryption algorithm. Alice and Bob share a secret key K in advance.

The sender Alice calculates the encryption function Enc using as inputs the secret key K, a nonce N, a header A, and a plaintext M so as to generate a ciphertext C and an authenticator Tag for tamper detection. The sender Alice sends the nonce N, the header A, the ciphertext C, and the authenticator Tag for tamper detection to the recipient Bob.

The recipient Bob calculates the decryption function Dec using as inputs the secret key K, the nonce N, the header A, the ciphertext C, and the authenticator Tag for tamper detection so as to determine whether no tampering has been detected, and generates the plaintext M if no tampering has occurred.

The header A is a value that may be made public. The sender Alice sets the nonce N to a different value for each encryption, and does not use the same value.

The security of the authenticated encryption algorithm includes confidentiality and integrity. The definitions of confidentiality and integrity are described in Non-Patent Literature 4.

Confidentiality is security that defines that a plaintext is not leaked from a ciphertext. In a confidentiality security game, an attacker accesses one of the encryption function Enc of the authenticated encryption algorithm and an oracle that outputs random numbers, and identifies which one is accessed. A probability of identification by the attacker is called an identification probability. The lower the identification probability, the higher the security of confidentiality.

Integrity is security that defines that public data or a ciphertext cannot be tampered with. In an integrity security game, an attacker accesses the encryption function Enc and the decryption function Dec of the authenticated encryption algorithm, inputs public data, a ciphertext, and an authenticator that have been falsified into the decryption function Dec, and aims to pass a tamper check. A probability of passing the tamper check is called a falsification probability. The lower the falsification probability, the higher the security of integrity.

One method for constructing an authenticated encryption algorithm is to use a block cipher.

A block cipher E is a function that takes as inputs a key component X of k bits and an input block Y of n bits, and outputs an output block Z of n bits. This is expressed as Z=E(X, Y). When the key X is fixed, the block cipher E is a permutation of n bits.

Examples of a block cipher include AES described in Non-Patent Literature 2, Skinny described in Non-Patent Literature 3, and so on. AES is an abbreviation for Advanced Encryption Standard.

In operations of the authenticated encryption algorithm, secret values that depend on a secret key and public values that do not depend on the secret key are used.

The (d+1)-order masking described in Non-Patent Literature 1, 4 to 7, and so on is a method for implementing countermeasures against side-channel attacks. In the (d+1)-order masking, a secret value is divided into d+1 values to protect a secret key. When the secret value is v bits, the secret value is divided into d+1 values of v bits in a masking implementation. This is designed such that the original secret value cannot be restored unless all the d+1 secret values are obtained. In the masking implementation, the secret value is calculated while the secret value remains being divided into the d+1 values. Therefore, the smaller the size of the secret value, the smaller the size of the masking implementation.

The minimum size of a secret value will be described. It is assumed that the security level that the authenticated encryption algorithm aims to achieve is s bits, and the block size of a plaintext is b bits. Apart from a secret value of s bits, a secret value is needed to encrypt each plaintext block of b bits. Therefore, the minimum value of the minimum size is s+b bits.

The security level s is designed to be 128 bits or higher in many schemes. The block size b of a plaintext is a value of 1 or greater.

Patent Literature 1 and Non-Patent Literature 8 describe authenticated encryption using a block cipher. For the target security level s, the size of a secret value is 2 s bits and the block size of a plaintext is b=s bits in this authenticated encryption. The minimum size of a secret value is achieved only when the block size of a plaintext is b=s bits, and the block size of a plaintext cannot be in any range other than b=s bits.

Non-Patent Literature 9 describes authenticated encryption using a block cipher. For the target security level s, the size of a secret value is 1.5s bits and the block size of a plaintext is b=0.5s bits in this authenticated encryption. The minimum size is achieved only when the block size of a plaintext is b=0.5s bits, and the block size of a plaintext cannot be in any range other than b=0.5s bits.

### CITATION LIST

### Patent Literature

Patent Literature 1: WO 2022-215249 A1

### Non-Patent Literature

Non-Patent Literature 1: Hannes Gross, Stefan Mangard, and Thomas Korak. Domain-oriented masking: Compact masked hardware implementations with arbitrary protection order. IACR ePrint 2016/486, 2016.
Non-Patent Literature 2: National Institute of Standards and Technology (NIST). Announcing the Advanced Encryption Standard (AES). FIPS PUB 197, 2001.
Non-Patent Literature 3: Christof Beierle, Jeremy Jean, Stefan Kolbl, Gregor Leander, Amir Moradi, Thomas Peyrin, Yu Sasaki, Pascal Sasdrich, and Siang Meng Sim. The SKINNY family of block ciphers and its low-latency variant MANTIS. In CRYPTO2016, pages 123-153, LNCS volume 9815, Springer, 2016.
Non-Patent Literature 4: Tetsu Iwata, Keisuke Ohashi, and Kazuhiko Minematsu. Breaking and Repairing GCM Security Proofs. CRYPTO 2012, Proceedings. pages 31-49. LNCS volume 7417. Springer. 2012.
Non-Patent Literature 5: Svetla Nikova, Christian Rechberger, and Vincent Rijmen. Threshold implementations against side-channel attacks and glitches. In Information and Communications Security, 8th International Conference, ICICS 2006, pages 529-545, LNCS volume 4307. Springer. 2006.
Non-Patent Literature 6: Oscar Reparaz, Begul Bilgin, Svetla Nikova, Benedikt Gierlichs, and Ingrid Verbauwhede. Consolidating masking schemes. In CRYPTO 2015, LNCS volume 9215, pages 764-783, Springer, 2015.
Non-Patent Literature 7: Gaetan Cassiers, Benjamin Gregoire, Itamar Levi, and Francois-Xavier Standaert. Hardware private circuits: From trivial composition to full verification. IEEE Trans. Computers, 70 (10):1677-1690, 2021.
Non-Patent Literature 8: Yusuke Naito, Yu Sasaki, Takeshi Sugawara. AES-LBBB: AES Mode for Lightweight and BBB-Secure Authenticated Encryption. IACR Trans. Cryptogr. Hardw. Embed. Syst. 2021 (3): 298-333 (2021).
Non-Patent Literature 9: Yusuke Naito, Yu Sasaki, and Takeshi Sugawara. Secret Can Be Public: Low-Memory AEAD Mode for High-Order Masking. CRYPTO2022: page 315-345.

### SUMMARY OF INVENTION

### Technical Problem

There exists authenticated encryption using a block cipher in which for the target security level s and the block size b of a plaintext, the size of a secret value is minimized only when b=s or b=0.5s.

An object of the present disclosure is to make it possible to realize a configuration that allows a secret value to be minimized to s+b bits when the block size b of a plaintext is set to any value.

### Solution to Problem

An authenticated encryption device according to the present disclosure includes
an initial processing unit to generate a secret value B from a secret key in authenticated encryption;
a function F processing unit to set the secret value B generated by the initial processing unit as an input block of a block cipher, and update the secret value B using the block cipher; and
a ciphertext processing unit to execute at least one of a process of encrypting a plaintext M and a process of decrypting a ciphertext C, using the secret value B updated by the function F processing unit.

### Advantageous Effects of Invention

In the present disclosure, a secret value B is set as an input block of a block cipher, and the secret value B is updated using the block cipher. This makes it possible to realize a configuration that allows a secret value to be minimized to s+b bits even when a block size b of a plaintext is set to any value.

When masking is implemented using the block ciphers described in Non-Patent Literature 2 and 3 by setting b<0.5 s, the implementation size can be reduced compared to cases where masking is implemented by the methods described in Patent Literature 1 and Non-Patent Literature 8 and 9.

### BRIEF DESCRIPTION OF DRAWINGS

FIG. 1 is a configuration diagram of an authenticated encryption device 10 according to Embodiment 1.

FIG. 2 is a diagram describing a block cipher E in Embodiment 1.

FIG. 3 is a diagram describing a function F according to Embodiment 1.

FIG. 4 is a flowchart of processes of the function F according to Embodiment 1.

FIG. 5 is a flowchart illustrating processes of an encryption function Enc according to Embodiment 1.

FIG. 6 is a flowchart of an initial process in the encryption function Enc according to Embodiment 1.

FIG. 7 is a diagram describing a header process in the encryption function Enc according to Embodiment 1.

FIG. 8 is a flowchart of the header process in the encryption function Enc according to Embodiment 1.

FIG. 9 is a diagram describing a main process in the encryption function Enc according to Embodiment 1.

FIG. 10 is a flowchart of the main process in the encryption function Enc according to Embodiment 1.

FIG. 11 is a diagram describing an authentication process in the encryption function Enc according to Embodiment 1.

FIG. 12 is a flowchart of the authentication process in the encryption function Enc according to Embodiment 1.

FIG. 13 is a diagram describing a main process in a decryption function Dec according to Embodiment 1.

FIG. 14 is a flowchart of the main process in the decryption function Dec according to Embodiment 1.

FIG. 15 is a flowchart of an authentication process in the decryption function Dec according to Embodiment 1.

FIG. 16 is a configuration diagram of the authenticated encryption device 10 according to Variation 1.

FIG. 17 is a diagram illustrating an example of the configuration of the authenticated encryption device 10 according to Variation 1.

### DESCRIPTION OF EMBODIMENTS

### Embodiment 1

### ***Description of Configuration***

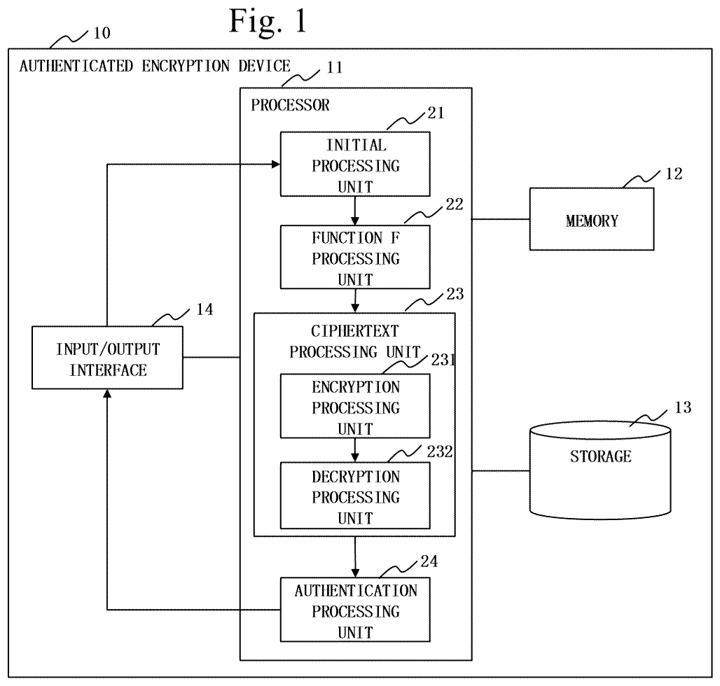

Referring to FIG. 1, a configuration of an authenticated encryption device 10 according to Embodiment 1 will be described.

The authenticated encryption device 10 is a computer.

The authenticated encryption device 10 includes hardware of a processor 11, a memory 12, a storage 13, and a communication interface 14. The processor 11 is connected to other hardware components via signal lines and controls these other hardware components.

The processor 11 is an IC that performs processing. IC is an abbreviation for integrated circuit. Specific examples of the processor 11 are a CPU, a DSP, and a GPU. CPU is an abbreviation for central processing unit. DSP is an abbreviation for digital signal processor. GPU is an abbreviation for graphics processing unit.

The memory 12 is a storage device to temporarily store data. Specific examples of the memory 12 are an SRAM and a DRAM. SRAM is an abbreviation for static random access memory. DRAM is an abbreviation for dynamic random access memory.

The storage 13 is a storage device to store data. A specific example of the storage 13 is an HDD. HDD is an abbreviation for hard disk drive. Alternatively, the storage 13 may be a portable recording medium such as an SD (registered trademark) memory card, CompactFlash (registered trademark), a NAND flash, a flexible disk, an optical disc, a compact disc, a Blu-ray (registered trademark) disc, or a DVD. SD is an abbreviation for Secure Digital. DVD is an abbreviation for digital versatile disk.

The communication interface 14 is an interface for communicating with external devices. Specific examples of the communication interface 14 are an Ethernet (registered trademark) port, a USB port, and an HDMI (registered trademark) port. USB is an abbreviation for Universal Serial Bus. HDMI is an abbreviation for High-Definition Multimedia Interface.

The authenticated encryption device 10 includes, as functional components, an initial processing unit 21, a function F processing unit 22, a ciphertext processing unit 23, and an authentication processing unit 24. The ciphertext processing unit 23 includes an encryption processing unit 231 and a decryption processing unit 232. The functions of the functional components of the authenticated encryption device 10 are realized by software.

The storage 13 stores programs that realize the functions of the functional components of the authenticated encryption device 10. These program are read into the memory 12 by the processor 11 and are executed by the processor 11. This realizes the functions of the functional components of the authenticated encryption device 10.

In FIG. 1, only one processor 11 is illustrated. However, there may be a plurality of processors 11, and the plurality of processors 11 may cooperate to execute the programs that realize the functions.

### ***Description of Operation***

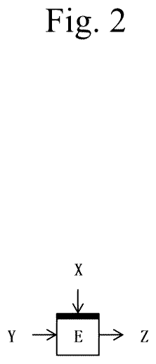

Referring to FIGS. 2 to 15, the operation of the authenticated encryption device 10 according to Embodiment 1 will be described.

A procedure for the operation of the authenticated encryption device 10 according to Embodiment 1 is equivalent to an authenticated encryption method according to Embodiment 1. A program that realizes the operation of the authenticated encryption device 10 according to Embodiment 1 is equivalent to an authenticated encryption program according to Embodiment 1.

### **Preliminary Description**

The operator indicated in Formula 1 represents an exclusive OR operator.

$$⊕ \qquad [ Formula 1 ]$$

Let 0ⁱ be an i-bit string of 0, and let 1ⁱ be an i-bit string of 1.

For a bit string X, the bit length of X is denoted as |X|. When X is an empty string, |X|=0.

For two bit strings X and Y, let X∥Y be a bit string obtained by concatenating the bits of X and Y in this order.

A function f is a surjective function that takes as inputs a nonce N, a counter value ctr, and a division value w, and outputs a value of c bits. That is, if (N, ctr, w)≠(N′, ctr′, w′), the function f is a function such that f(N, ctr, w)≠f(N′, ctr′, w′).

An example of the function f is a function where c1, c2, and c3 are c=c1+c2+c3, Nis c1 bits, ctr is c2 bits, wis c3 bits, and f(N, ctr, w)=N∥ctr∥w.

In the following examples, ctr and w are expressed as integers. They are to be converted to bit strings in actual usage.

A function ozp[i] is a function that takes as an input a value of i bits or less and outputs a value of i bits. The function ozp[i] is injective for inputs of i−1 bits or less.

An example of the function ozp[i] is the following function. For a value V that is between 1 bit and i−1 bits, the output of a function ozp[i](V) is a value obtained by concatenating a bit of 1 after V and then further concatenating a bit string of 0 so that the bit length is i. For a value V of i bits, the output of the function ozp[i](V) is the value V. For an empty string V, the output of the function ozp[i](V) is 0ⁱ.

A function zp[i] is a function that takes as an input a value of i bits or less and outputs a value of i bits. The function zp[i] is a function that outputs different values for two different input values with the same bit length.

An example of the function zp[i] is the following function. For a value V that is between 1 bit and i−1 bits, the output of a function zp[i](V) is a value obtained by concatenating a bit string of 0 after V so that the bit length is i. For a value V of i bits, the output of the function zp[i](V) is the value V.

A function tr[i] is a function that outputs a predetermined i bits of an input bit string when the input is a bit string of i bits or more. An example of the function tr[i] is a function that outputs the most significant i bits or the least significant i bits of an input bit string.

The function tr[i] is an injective function when the input is a bit string that is between 1 bit and i−1 bits. Examples of the function tr[i] are the functions described as the examples of the function zp[i] and the function ozp[i].

Let b be an integer satisfying 0<b≥n, where n represents the size of an input block of a block cipher. Let t be an integer satisfying 0<t. Let r be an integer satisfying 0<r. Let w be an integer satisfying t/b≤w. Let the length of an encryption key of the block cipher be k=r+c.

### **Function F**

The authenticated encryption device 10 constructs authenticated encryption using a function F. In the function F, a block cipher E is used.

Referring to FIG. 2, the block cipher E in Embodiment 1 will be described. The block cipher E is a function that takes as inputs a key component X of k bits and an input block Y of n bits, and outputs an output block Z of n bits. This block cipher E is depicted as indicated in FIG. 2.

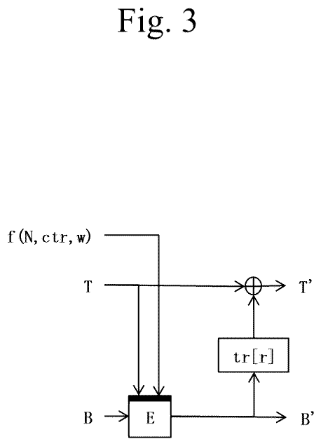

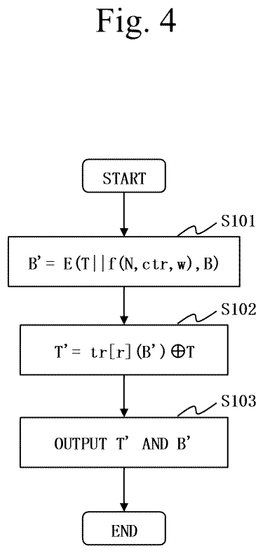

Referring to FIGS. 3 and 4, the function F according to Embodiment 1 will be described.

The function F is a function that takes as inputs a value T of r bits, a value B of n bits, a nonce N, a counter value ctr, and a division value w, and outputs a value T′ of r bits and a value B′ of n bits. That is, (T′, B′)=F(N, ctr, w, T, B). The counter value ctr is counted for each process and a different value is set. The function F is processed by the function F processing unit 22.

Processes of the function F will be described specifically.

### (Step S101: B Update Process)

The function F processing unit 22 sets a value obtained by concatenating a value T and then an output value obtained by inputting a nonce N, a counter value ctr, and a division value w into the function f as a key component of the block cipher E. The function F processing unit 22 sets a value B as an input block of the block cipher E. Then, the function F processing unit 22 calculates the block cipher E so as to update the value B to generate a value B′.

### (Step S102: T Update Process)

The function F processing unit 22 performs an exclusive OR operation on an output value obtained by inputting the value B′ into a function tr[r] and the value T so as to update the value T to generate a value T′.

### (Step S103: Output Process)

The function F processing unit 22 outputs a set of the value T′ of r bits and the value B′ of n bits.

### **Encryption Function Enc**

An encryption function Enc in the authenticated encryption realized by the authenticated encryption device 10 according to Embodiment 1 will be described.

The input values of the encryption function Enc are a secret key K of r+n bits, a nonce N, a header A, and a plaintext M. The header A may be an empty string. The plaintext M may be an empty string.

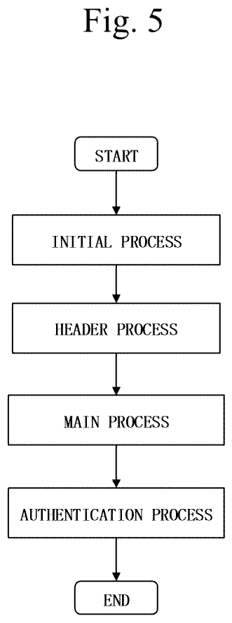

As indicated in FIG. 5, an initial process, a header process, a main process, and an authentication process are sequentially executed in the encryption function Enc. The initial process, the header process, the main process, and the authentication process will be described below.

### <Initial Process>

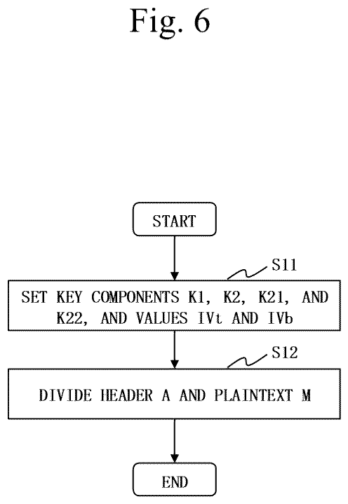

Referring to FIG. 6, the initial process in the encryption function Enc according to Embodiment 1 will be described.

The initial process in the encryption function Enc is a process of setting values and the like to be used in the processes to be described later.

### (Step S11: Key Component Setting Process)

The initial processing unit 21 sets the most significant r bits of the secret key K as a key component K1, and sets the least significant n bits as a key component K2. The initial processing unit 21 sets the most significant b bits of the key component K2 as a key component K21, and sets the remaining n-b bits as a key component K22. That is, K=K1∥K2 and K2=K21∥K22.

The initial processing unit 21 may extract the key component K1 as predetermined r bits of the secret key K, and set the key component K2 to be the remaining n bits of the secret key K. Similarly, the initial processing unit 21 may extract the key component K21 as predetermined b bits of the key component K2, and set the key component K22 to be the remaining n-b bits of the key component K2.

The initial processing unit 21 sets the key component K1 as a value IVt, and sets the key component K2 as a value IVb. The value IVt and the value IVb are used in the header process.

### (Step S12: Division Process)

The initial processing unit 21 divides the header A and the plaintext M.

Specifically, the initial processing unit 21 divides the header A into header elements A[1], A[2], . . . , and A[a] every n bits from the beginning. The initial processing unit 21 divides the plaintext M into plaintext elements M[1], M[2], . . . , and M[m] every b bits from the beginning.

If the header A is not an empty string, each of the header elements A[1], A[2], . . . , and A[a−1] is n bits, and the header element A[a] is a value that is between 1 bit and n bits. The header A is a value obtained by concatenating the bits of the header elements A[1], A[2], . . . , and A[a]. If the header A is an empty string, a=1 and the header element A[1] is an empty string.

If the plaintext M is not an empty string, each of the plaintext elements M[1], M[2], . . . , M[m−1] is b bits, and the plaintext element M[m] is a value that is between 1 bit and b bits. The plaintext Mis a value obtained by concatenating the bits of the plaintext elements M[1], M[2], . . . , and M[m]. If the plaintext M is an empty string, m=1 and the plaintext element M[1] is an empty string.

### <Header Process>

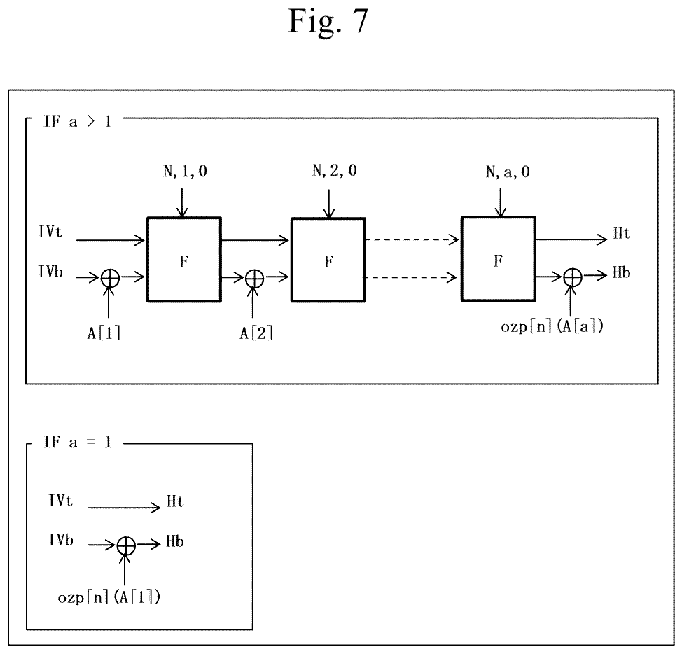

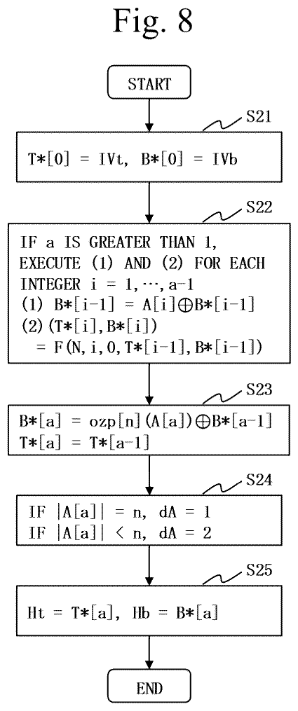

Referring to FIGS. 7 and 8, the header process in the encryption function Enc according to Embodiment 1 will be described.

The header process in the encryption function Enc is a process of processing the header elements A[1], A[2], . . . , and A[a] generated in the initial process, using the value IVt and the value IVb that are set in the initial process, and generating a value Ht, a value Hb, and a division value dA.

### (Step S21: Initial Value Setting Process)

The function F processing unit 22 sets the value IVt as a value T*[0], and sets the value IVb as a value B*[0].

### (Step S22: Function F Process)

If a value a, which is a division number of the header A, is greater than 1, the function F processing unit 22 executes the following processes (1) and (2) for each integer i in ascending order, where i=1, . . . , a−1. If the value a, which is the division number of the header A, is 1, the function F processing unit 22 sets the value T*[0] as a value T*[a−1], and sets the value B*[0] as a value B*[a−1].

(1) The function F processing unit 22 sets the exclusive OR of a value a[i] and a value B*[i−1] as the value B*[i−1].

(2) The function F processing unit 22 calculates the function F using as inputs the nonce N, the integer i, 0, a value T*[i−1], and the value B*[i−1] to generate a value T*[i] and a value B*[i].

Note that the value T*[0] and the value B*[0] are secret values generated from the secret key in the authenticated encryption. That is, the function F processing unit 22 sets a value generated using the secret value T*[i−1], the nonce N, the value i, which is the counter value ctr, and the division number (0 in this case) as a key component of the block cipher E. The function F processing unit 22 sets the secret value B*[i−1] as an input block of the block cipher E. Then, the function F processing unit 22 updates the secret value T*[i−1] and the secret value B*[i−1] using the block cipher E to generate the secret value T*[i] and the secret value B*[i].

### (Step S23: Value B Update Process)

The function F processing unit 22 sets the exclusive OR of an output value obtained by inputting the value A[i] into a function ozp[n] and the value B*[a−1] as a value B*[a]. The function F processing unit 22 sets the value T*[a−1] as a value T*[a].

### (Step S24: Value dA Setting Process)

The function F processing unit 22 sets the value dA depending on whether or not |A[a]| is equal to n. In Embodiment 1, if |A[a]| is equal to n, the function F processing unit 22 sets the value dA to 1. If |A[a]| is less than n, the function F processing unit 22 sets the value dA to 2.

### (Step S25: Output Value Setting Process)

The function F processing unit 22 sets the value T*[a] as the value Ht, and sets value B*[a] as the value Hb.

The function F processing unit 22 may update a value T[i−1] with a certain permutation P1 of r bits before (1) of step S22. Similarly, the function F processing unit 22 may update a value B[i−1] with a certain permutation P2 of n bits before (1) of step S22. The function F processing unit 22 may update a value T[i] with a certain permutation P1′ of r bits after (2) of step S22. Similarly, the function F processing unit 22 may update a value B[i] with a certain permutation P2′ of n bits after (2) of step S22. Instead of the exclusive OR used in the header process, other operations such as addition, subtraction, and multiplication may be used.

### <Main Process>

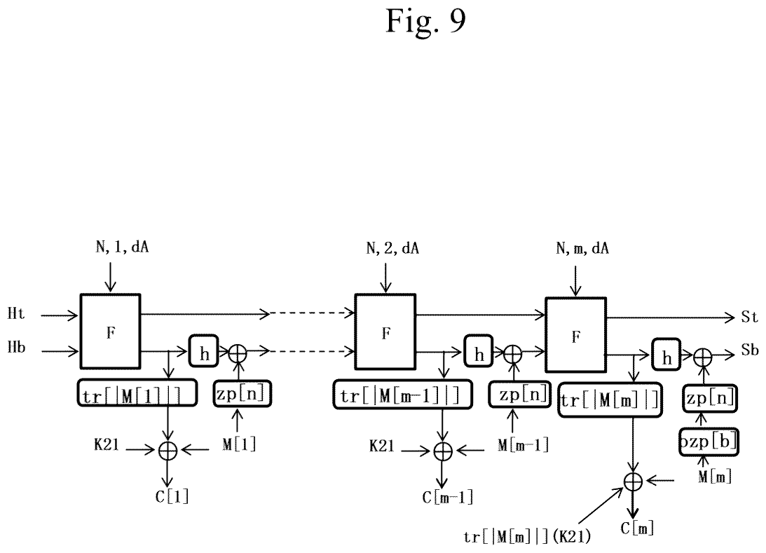

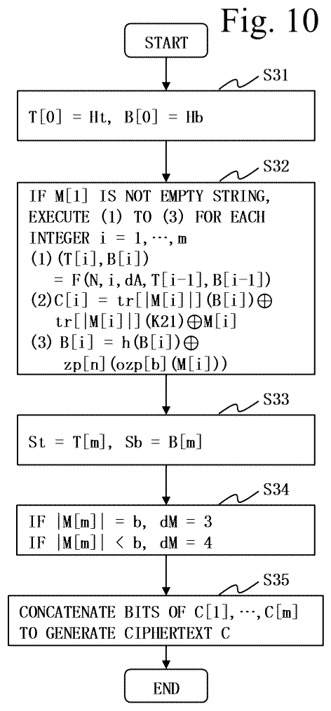

Referring to FIGS. 9 and 10, the main process in the encryption function Enc according to Embodiment 1 will be described.

The main process in the encryption function Enc is a process of processing the plaintext elements M[1], M[2], . . . , and M[m] generated in the initial process, using the value Ht, the value Hb, and the value dA that are set in the header process so as to generate a value St, a value Sb, a value dM, and a ciphertext C.

Note that a function h in the following process is a permutation of n bits. The function h is a permutation such that for a value S of n bits and a variable Z, Formula 2 has a unique solution for the variable Z.

$$h ( Z ) ⊕ Z = S \qquad [ Formula 2 ]$$

For example, one method for the function h is to use multiplication of a generator on GF(2n). That is, h(Z)=u·Z, where u is a generator.

### (Step S31: Initial Value Setting Process)

The function F processing unit 22 sets the value Ht as a value T[0], and sets the value Hb as a value B[0].

### (Step S32: Function F Process)

If the plaintext element M[1] is not an empty string, the function F processing unit 22 executes the following processes (1) to (3) for each integer i in ascending order, where i=1, . . . , m. If the plaintext element M[1] is an empty string, the function F processing unit 22 sets the value T[0] as a value T[m], and sets the value B[0] as a value B[m].

(1) The function F processing unit 22 calculates the function F using as inputs the nonce N, the integer i, the value dA, the value T[i−1], and the value B[i−1] to generate a value T[i] and a value B[i].

Note that the value T[0] and the value B[0] are secret values updated in the header process. That is, the function F processing unit 22 sets a value generated using the secret value T[i−1], the nonce N, the value i, which is the counter value ctr, and the division number (dA in this case) as a key component of the block cipher E. The function F processing unit 22 sets the secret value B[i−1] as an input block of the block cipher E. Then, the function F processing unit 22 updates the secret value T[i−1] and the secret value B[i−1] using the block cipher E to generate the secret value T[i] and the secret value B[i].

(2) The encryption processing unit 231 of the ciphertext processing unit 23 generates a cipher element C[i] using the secret value B[i] generated by updating the secret value B[i−1] by the function F processing unit 22.

Specifically, the encryption processing unit 231 sets the exclusive OR of an output value obtained by inputting the value B[i] into a function tr[|M[i]|], an output value obtained by inputting the value K21 in the function tr[|M[i]|], and a plaintext element M[i] as the cipher element C[i]. Note that if the integer i≠m, M[i]| is b bits, so that there is no need to convert the value K21 using the function tr[|M[i]|]. That is, the same result can be obtained by inputting the value K21 directly into the exclusive OR, instead of the output value obtained by inputting the value K21 into the function tr[|M[i]|].

(3) The function F processing unit 22 sets the exclusive OR of an output value obtained by inputting the value B[i] into the function h and an output value obtained by inputting an output value obtained by inputting the plaintext element M[i] into a function ozp[b] into a function zp[n] as the value B[i]. Note that if the integer i≠m, |M[i]| is b bits, so that there is no need to use the function ozp[b]. That is, the same result can be obtained by inputting the plaintext element M[i] directly into the function zp[n], instead of the output value obtained by inputting the plaintext element M[i] into the function ozp[b].

### (Step S33: Output Value Setting Process)

The function F processing unit 22 sets the value T[m] as the value St, and sets the value B[m] as the value Sb.

### (Step S34: Value dM Process)

The function F processing unit 22 sets the value dM depending on whether or not |M[m]| is equal to b. In Embodiment 1, if |M[m]| is equal to b, the function F processing unit 22 sets the value dM to 3. If |M[m]| is less than b, the function F processing unit 22 sets the value dM to 4.

### (Step S35: Ciphertext Generation Process)

The encryption processing unit 231 of the ciphertext processing unit 23 generates the ciphertext C by concatenating the bits of the cipher elements C[1], . . . , and C[m] generated in (2) of step S32. For example, the encryption processing unit 231 sets the ciphertext C as C[1]∥C[2]∥ . . . ∥C[m].

The process of (2) of S32 and the process of step S35 are an encryption process. In the encryption process, the encryption processing unit 231 generates the cipher element C[i] from the secret value B[i] generated by the function F processing unit 22 for each integer i, where i=1, . . . , m. Then, the encryption processing unit 231 generates the ciphertext C, which is the encrypted plaintext M, using the cipher element C[i] for each integer i, where i=1, . . . , m.

The function F processing unit 22 may update the value T[i−1] with a certain permutation of r bits before (1) of step S32. Similarly, the function F processing unit 22 may update the value B[i−1] with a certain permutation of n bits before (1) of step S32. The function F processing unit 22 may update the value T[i] with a certain permutation of r bits after (3) of step S32. Similarly, the function F processing unit 22 may update the value B[i] with a certain permutation of n bits after (3) of step S32. Instead of the exclusive OR used in the main process, other operations such as addition, subtraction, and multiplication may be used.

### <Authentication Process>

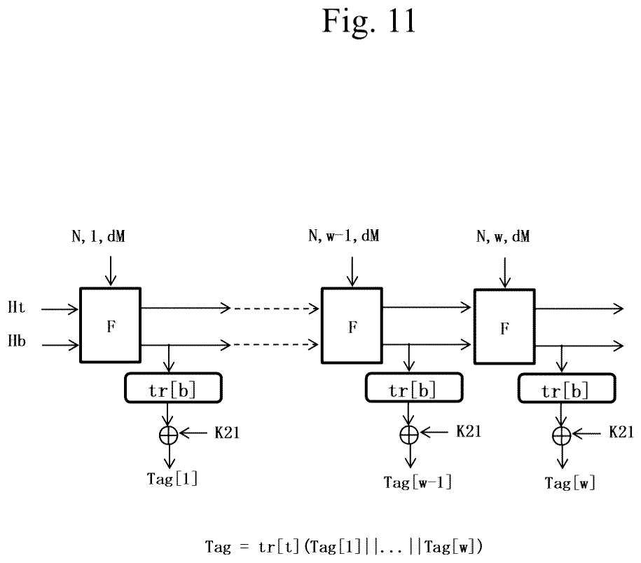

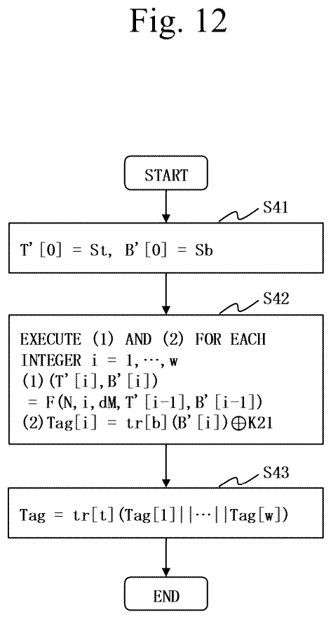

Referring to FIGS. 11 and 12, the authentication process in the encryption function Enc according to Embodiment 1 will be described.

The authentication process in the encryption function Enc is a process of generating an authenticator Tag using the value St, the value Sb and the value dM that are set in the main process.

### (Step S41: Initial Value Setting Process)

The function F processing unit 22 sets the value St as a value T′[0], and sets the value Sb as a value B′[0].

### (Step S42: Function F Process)

The function F processing unit 22 executes the following processes (1) and (2) for each integer i in ascending order, where i=1, . . . , w, and w is a preset value.

(1) The function F processing unit 22 calculates the function F using as inputs the nonce N, the integer i, the value dM, a value T′[i−1], and a value B′[i−1] to generate a value T′[i] and a value B′[i].

Note that the value T′[0] and the value B′[0] are secret values updated in the main process. That is, the function F processing unit 22 sets a value generated using the secret value T′[i−1], the nonce N, the value i, which is the counter value ctr, and the division number (dM in this case) as a key component of the block cipher E. The function F processing unit 22 sets the secret value B′[i−1] as an input block of the block cipher E. Then, the function F processing unit 22 updates the secret values T′[i−1] and the secret vale B′[i−1] using the block cipher E to generate the secret value T′[i] and the secret value B′[i].

(2) The authentication processing unit 24 sets the exclusive OR of an output value obtained by inputting the secret value B′[i] into a function tr[b] and the value K21 as an authentication element Tag[i].

### (Step S43: Authenticator Generation Process)

The authentication processing unit 24 generates the authenticator Tag by concatenating the bits of the authentication elements Tag[1], . . . , Tag[w] generated in (2) of step S42. For example, the authentication processing unit 24 sets the authenticator Tag as tr[t](Tag[1]∥ . . . ∥Tag[w]).

### **Decryption Function Dec**

A decryption function Dec in the authenticated encryption realized by the authenticated encryption device 10 according to Embodiment 1 will be described.

The input values of the decryption function Dec are a secret key K of r+n bits, a nonce N, a header A, a ciphertext C, and an authenticator Tag′ for tamper detection. Note that the authenticator Tag′ given as an input value of the decryption function Dec is the authenticator Tag generated by the encryption function Enc. The authenticator given as an input value of the decryption function Dec will be described as the authenticator Tag′ in order to distinguish it from an authenticator Tag to be generated in the following description.

In the decryption function Dec, an initial process, a header process, a main process, and an authentication process are sequentially executed, as in the encryption function Enc. The initial process, the main process, and the authentication process will be described below. The header process is the same as that in the encryption function Enc.

### <Initial Process>

Referring to FIG. 6, the initial process in the decryption function Dec according to Embodiment 1 will be described.

The initial process in the decryption function Dec is a process of setting values and the like to be used in the processes to be described later.

The process of step S11 is the same as the process in the encryption function Enc.

### (Step S12: Division Process)

The initial processing unit 21 divides the header A and the ciphertext C.

Specifically, the initial processing unit 21 divides the header A into header elements A[1], A[2], . . . , and A[a], as in the encryption function Enc. The initial processing unit 21 divides the ciphertext C into cipher elements C[1], C[2], . . . , and C[m] every b bits from the beginning.

If the ciphertext C is not an empty string, each of the cipher elements C[1], C[2], . . . , and C[m−1] is b bits, and the cipher element C[m] is a value that is between 1 bit and b bits. The ciphertext C is a value obtained by concatenating the bits of the cipher elements C[1], C[2], . . . , and C[m]. If the ciphertext C is an empty string, m=1 and the cipher element C[1] is an empty string.

### <Main Process>

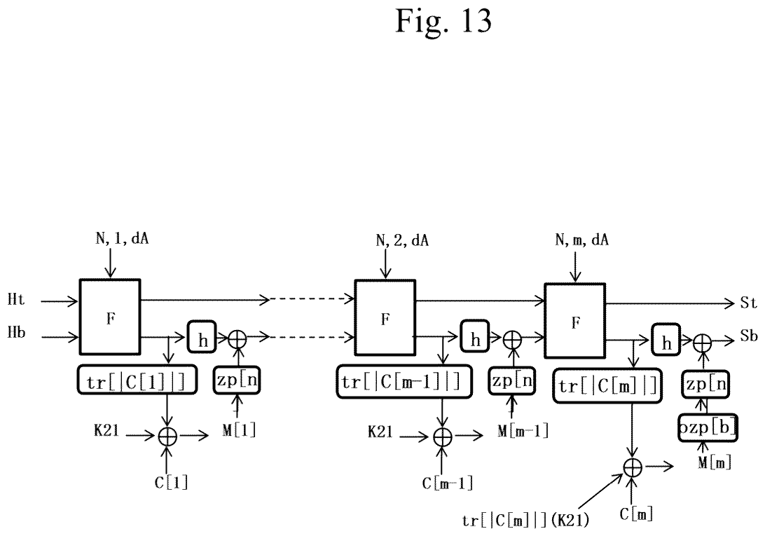

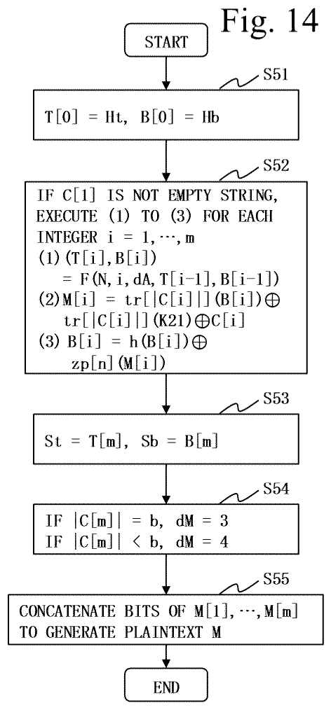

Referring to FIGS. 13 and 14, the main process in the decryption function Dec according to Embodiment 1 will be described.

The main process in the decryption function Dec is a process of processing the cipher elements C[1], C[2], . . . , and C[m] generated in the initial process, using the value Ht, the value Hb, and the value dA that are set in the header process so as to generate a value St, a value Sb, a value dM, and a plaintext M.

Note that the function h in the following process is a permutation of n bits, like the function h used in the main process in the encryption function Enc.

The process of step S51 is the same as the process of step S31 in FIG. 10. The process of step S53 is the same as the process of step S33 in FIG. 10.

### (Step S52: Function F Process)

If the cipher element C[1] is not an empty string, the function F processing unit 22 executes the following processes (1) to (3) for each integer i in ascending order, where i=1, . . . , m.

The process of (1) is the same as the process of (1) of step S32 in FIG. 10. The process of (3) is the same as the process of (3) of step S32 in FIG. 10.

(2) The decryption processing unit 232 of the ciphertext processing unit 23 generates a plaintext element M[i] using the secret value B[i] generated by updating the secret value B[i−1] by the function F processing unit 22.

Specifically, the decryption processing unit 232 sets, as the plaintext element M[i], the exclusive OR of an output value obtained by inputting the value B[i] into a function tr[|C[i]|], an output value obtained by inputting the value K21 into the function tr[|C[i]|], and the cipher element C[i]. Note that if the integer i+m, |C[i]| is b bits, so that there is no need to convert the value K21 using the function tr[|C[i]|]. That is, the same result can be obtained by inputting the value K21 directly into the exclusive OR, instead of the output value obtained by inputting the value K21 into the function tr[|C[i]|].

### (Step S54: Value dM Process)

The function F processing unit 22 sets the value dM depending on whether or not |C[m]| is equal to b. In Embodiment 1, if |C[m]| is equal to b, the function F processing unit 22 sets the value dM to 3. If |C[m]| is less than b, the function F processing unit 22 sets the value dM to 4.

### (Step S55: Plaintext Generation Process)

The decryption processing unit 232 of the ciphertext processing unit 23 generates the plaintext M by concatenating the bits of the plaintext elements M[1], . . . , and M[m] generated in (2) of step S52. For example, the decryption processing unit 232 sets the plaintext M as M[1]∥M[2]∥ . . . ∥M[m].

The process of (2) of step S52 and the process of step S55 are a decryption process. In the decryption process, the decryption processing unit 232 generates the plaintext element M[i] from the secret value B[i] generated by the function F processing unit 22, for each integer i, where i=1, . . . , m. Then, the decryption processing unit 232 generates the plaintext M, which is the decrypted ciphertext C, using the plaintext element M[i] for each integer i, where i=1, . . . , m.

The function F processing unit 22 may update the value T[i−1] with a certain permutation of r bits before (1) of step S52. Similarly, the function F processing unit 22 may update the value B[i−1] with a certain permutation of n bits before (1) of step S52. The function F processing unit 22 may update the value T[i] with a certain permutation of r bits after (3) of step S52. Similarly, the function F processing unit 22 may update the value B[i] with a certain permutation of n bits after (3) of step S52. Instead of the exclusive OR used in the main process, other operations such as addition, subtraction, and multiplication may be used.

### <Authentication Process>

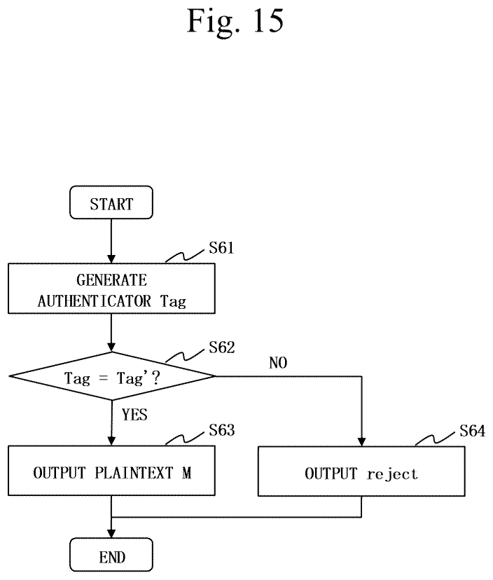

Referring to FIG. 15, the authentication process in the decryption function Dec according to Embodiment 1 will be described.

### (Step S61: Authenticator Generation Process)

The authenticated encryption device 10 executes the processes of step S41 to step S43 in FIG. 12 described in the authentication process in the encryption function Enc. As a result, the authenticated encryption device 10 generates an authenticator Tag.

### (Step S62: Tamper Determination Process)

The authentication processing unit 24 determines whether the authenticator Tag generated in step S61 matches the authenticator Tag′ given as an input.

If the authenticator Tag matches the authenticator Tag′, the authentication processing unit 24 advances the process to step S63. If the authenticator Tag does not match the authenticator Tag′, the authentication processing unit 24 advances the process to step S64.

### (Step S63: Plaintext Output Process)

The authentication processing unit 24 outputs the plaintext M generated in the main process.

### (Step S64: Falsification Information Output Process)

The authentication processing unit 24 outputs reject, which is a value indicating falsification.

### ***Effects of Embodiment 1***

As described above, the authenticated encryption device 10 according to Embodiment 1 sets the secret value B as an input block of a block cipher, and updates the secret value B using the block cipher. This realizes a configuration that allows a secret value to be minimized to s+b bits even when the block size b of a plaintext is set to any value.

Specifically, the authenticated encryption realized by the authenticated encryption device 10 according to Embodiment 1 is s-bit secure authenticated encryption for the target security level s when the number of bits r and the number of bits n are set as r+n=s.

The authenticated encryption realized by the authenticated encryption device 10 according to Embodiment 1 can be used as a tamper detection algorithm by setting the plaintext M and the ciphertext C as empty strings.

The authenticated encryption realized by the authenticated encryption device 10 according to Embodiment 1 may be configured such that for one secret key K for the authenticated encryption, a random number of the same length as or a shorter length than a nonce is fixed, and the exclusive OR of this random number and the nonce is used as a new nonce. In addition to the random number for updating the nonce, a random number of the same length as or a shorter length than a counter value may be fixed for one secret key K, and the exclusive OR of this random number and each counter value may be used as a new counter value.

By updating the nonce and the counter value using the exclusive OR of the nonce and a random number and the exclusive OR of the counter value and a random number, respectively, the multi-user security of authenticated encryption described in the following document can also be secured. One random number is fixed for one key, and a different random number needs to be used each time the key is changed. Document (Viet Tung Hoang, Stefano Tessaro, Aishwarya Thiruvengadam: The Multi-user Security of GCM, Revisited: Tight Bounds for Nonce Randomization. CCS 2018. ACM. pp. 1429-1440).

Note that the security described by referring to Non-Patent Literature 4 in Background Art is for single users.

### ***Other Configurations***

### <Variation 1>

In Embodiment 1, the functional components are realized by software. However, as Variation 1, the functional components may be realized by hardware. With regard to this Variation 1, differences from Embodiment 1 will be described.

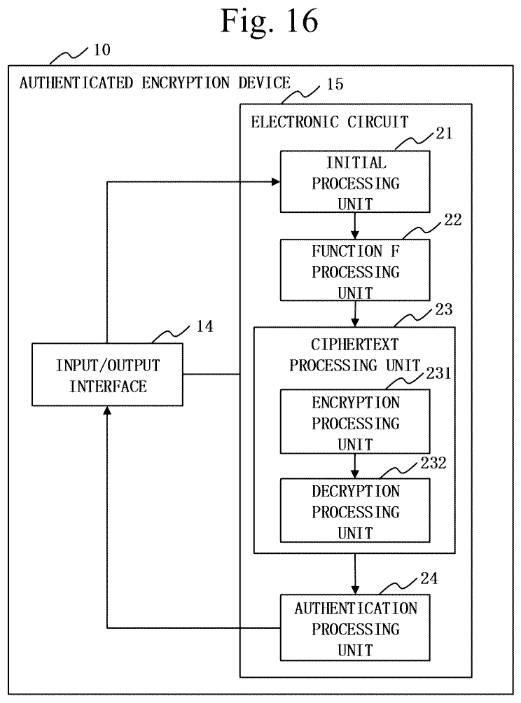

Referring to FIG. 16, a configuration of the authenticated encryption device 10 according to Variation 1 will be described.

When the functional components are realized by hardware, the authenticated encryption device 10 includes an electronic circuit 15 in place of the processor 11, the memory 12, and the storage 13. The electronic circuit 15 is a dedicated circuit that realizes the functions of the functional components, the memory 12, and the storage 13.

The electronic circuit 15 is assumed to be a single circuit, a composite circuit, a programmed processor, parallel-programmed processors, a logic IC, a gate array (GA), an application specific integrated circuit (ASIC), or a field-programmable gate array (FPGA).

The functional components may be realized by one electronic circuit 15, or may be distributed among and realized by a plurality of electronic circuits 15.

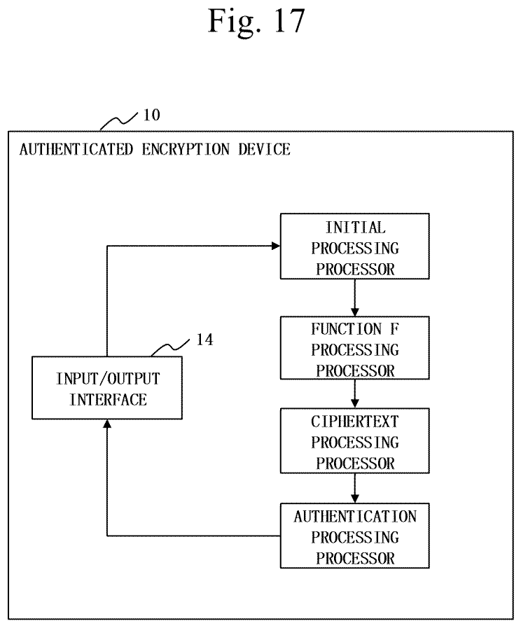

For example, as illustrated in FIG. 17, the authenticated encryption device 10 may be configured to include, as the electronic circuit 15, an initial processing processor that performs the processes of the initial processing unit 21, a function F processing processor that performs the processes of the function F processing unit 22, a ciphertext processing processor that performs the processes of the ciphertext processing unit 23, and an authentication processing processor that performs the processes of the authentication processing unit 24.

A block cipher processor that performs the processes of the block cipher E among the processes of the function F processing unit 22 may be provided separately from the function F processing processor. The ciphertext processing processor may be divided into an encryption processing processor that performs the processes of the encryption processing unit 231 and a decryption processing processor that performs the processes of the decryption processing unit 232. The authentication processing processor may be divided into an authenticator generation processor that generates an authenticator Tag and a tamper determination processor that performs the tamper determination process.

### <Variation 2>

As Variation 2, some of the functional components may be realized by hardware, and the rest of the functional components may be realized by software.

The processor 11, the memory 12, the storage 13, and the electronic circuit 15 are referred to as processing circuitry. That is, the functions of the functional components are realized by the processing circuitry.

### <Variation 3>

In Embodiment 1, the authenticated encryption device 10 realizes both the encryption function Enc and the decryption function Dec. However, the authenticated encryption device 10 may realize only one of the encryption function Enc and the decryption function Dec. When the authenticated encryption device 10 realizes only one of the encryption function Enc and the decryption function Dec, the authenticated encryption device 10 only needs to include functional components necessary for this realization. Specifically, when the authenticated encryption device 10 realizes only the encryption function Enc, the decryption processing unit 232 of the ciphertext processing unit 23 is not necessary. When the authenticated encryption device 10 realizes only the decryption function Dec, the encryption processing unit 231 of the ciphertext processing unit 23 is not necessary.

“Unit” in the above description may be interpreted as “circuit”, “step”, “procedure”, “process”, or “processing circuitry”.

The embodiments and variations of the present disclosure have been described above. Two or more of these embodiments and variations may be implemented in combination. Alternatively, one or more of them may be partially implemented. Note that the present disclosure is not limited to the above embodiments and variations, and various modifications can be made as necessary.

### REFERENCE SIGNS LIST

10: authenticated encryption device; 11: processor; 12: memory; 13: storage; 14: communication interface; 15: electronic circuit; 21: initial processing unit; 22: function F processing unit; 23: ciphertext processing unit; 231: encryption processing unit; 232: decryption processing unit; 24: authentication processing unit.

1. An authenticated encryption device comprising
processing circuitry to:
generate a key component K1 of r bits extracted from a secret key of r+n bits in authenticated encryption, and generate a key component K2 of n bits as a secret value B, the key component K2 being the n bits that remain after the key components K1 is extracted from the secret key;
set a value generated using a value T that is the key component K1 as a key component of a block cipher, set the secret value B as an input block of the block cipher, and update the secret value B using the block cipher; and
execute at least one of a process of encrypting a plaintext M and a process of decrypting a ciphertext C, using the secret value B that has been updated.

2. The authenticated encryption device according to claim 1,
wherein the processing circuitry sets a value generated using a nonce given as an input in the authenticated encryption in addition to the value T as a key component of the block cipher.

3. The authenticated encryption device according to claim 1,
wherein the processing circuitry repeats a process of setting a new secret value B generated by updating the secret value B as an input block of the block cipher, setting a value generated using a new value T generated from the new secret value B and the value T as a key component of the block cipher, and updating the secret value B using the block cipher.

4. The authenticated encryption device according to claim 1,
wherein the processing circuitry sets the secret value B used in one of the process of encrypting the plaintext M and the process of decrypting the ciphertext C as an input block of the block cipher, and further updates the secret value B using the block cipher, and
wherein the processing circuitry generates an authenticator Tag using the secret value B that has been further updated.

5. The authenticated encryption device according to claim 4,
wherein the processing circuitry sets the secret value B used in one of a process of encrypting a plaintext M and a process of decrypting a ciphertext C as a secret value B′[0], sets a secret value B′[i−1] as an input block of a block cipher, and updates the secret value B′[i−1] using the block cipher to generate a secret value B′[i], for each integer i in ascending order, where i=1, . . . , w, and
wherein the processing circuitry generates an authentication element Tag[i] using the secret value B′[i] for each integer i, where i=1, . . . , w, and generates the authenticator Tag using the authentication element Tag[i] for each integer i, where i=1, . . . , w.

6. The authenticated encryption device according to claim 5,
wherein the processing circuitry generates the authentication element Tag[i] using a key component K21 that is at least part of an initial value of the secret value B, for each integer i, where i=1, . . . , w.

7. An authenticated encryption device comprising
processing circuitry to:
generate a secret value B from a secret key in authenticated encryption;
set the secret value B as an input block of a block cipher, update the secret value B using the block cipher, set a secret value B at a certain time point as a secret value B[0], set a secret value B[i−1] as an input block of a block cipher, and update the secret value B[i−1] using the block cipher to generate a secret value B[i], for each integer i in ascending order, where i=1, . . . , m; and
execute at least one of a process of encrypting a plaintext M and a process of decrypting a ciphertext C using the secret value B[i] for each integer i, where i=1, . . . , m.

8. The authenticated encryption device according to claim 7,
wherein the processing circuitry executes at least one of
an encryption process of generating a cipher element C[i] from the secret value B[i] for each integer i, where i=1, . . . , m, and a plaintext element M[i] generated by dividing a plaintext M into m pieces, and generating a ciphertext C, which is the plaintext M that is encrypted, using the cipher element C[i] for each integer i, where i=1, . . . , m, and
a decryption process of generating a plaintext element M[i] from the secret value B[i] for each integer i, where i=1, . . . , m, and a cipher element C[i] obtained by dividing a ciphertext C, and generating a plaintext M, which is the ciphertext C that is decrypted, using the plaintext element M[i] for each integer i, where i=1, . . . , m.

9. The authenticated encryption device according to claim 8,
wherein in the encryption process, the processing circuitry generates the cipher element C[i] using a key component K21 that is at least part of an initial value of the secret value B, for each integer i, where i=1, . . . , m, and
wherein in the decryption process, the processing circuitry generates the plaintext element M[i] using a key component K21 that is at least part of an initial value of the secret value B, for each integer i, where i=1, . . . , m.

10. The authenticated encryption device according to claim 7,
wherein the processing circuitry sets the secret value B used in one of the process of encrypting the plaintext M and the process of decrypting the ciphertext C as an input block of the block cipher, and further updates the secret value B using the block cipher, and
wherein the processing circuitry generates an authenticator Tag using the secret value B that has been further updated.

11. The authenticated encryption device according to claim 10,
wherein the processing circuitry sets the secret value B used in one of a process of encrypting a plaintext M and a process of decrypting a ciphertext C as a secret value B′[0], sets a secret value B′[i−1] as an input block of a block cipher, and updates the secret value B′[i−1] using the block cipher to generate a secret value B′[i], for each integer i in ascending order, where i=1, . . . , w, and
wherein the processing circuitry generates an authentication element Tag[i] using the secret value B′[i] for each integer i, where i=1, . . . , w, and generates the authenticator Tag using the authentication element Tag[i] for each integer i, where i=1, . . . , w.

12. The authenticated encryption device according to claim 11,
wherein the processing circuitry generates the authentication element Tag[i] using a key component K21 that is at least part of an initial value of the secret value B, for each integer i, where i=1, . . . , w.

13. The authenticated encryption device according to claim 7,
wherein the processing circuitry executes a header process of updating the secret value B with a header A given as an input in the authenticated encryption, then setting the secret value B that has been updated as an input block of the block cipher, and updating the secret value B using the block cipher, and sets the secret value B at a time point after being updated by the header process as a secret value B[0].

14. The authenticated encryption device according to claim 13,
wherein the processing circuitry executes the header process of setting the secret value B as a secret value B*[0], updating a secret value B*[i−1] using a header element A[i] of header elements A[1], . . . , A[a] obtained by dividing the header A into “a” pieces, then setting the secret value B*[i−1] that has been updated as an input block of a block cipher, updating the secret value B*[i−1] using the block cipher to generate a secret value B*[i], for each integer i in ascending order, where i=1, . . . , a−1, and updating a secret value B*[a−1] with the header element A[a].

15. An authenticated encryption method comprising:
generating a key component K1 of r bits extracted from a secret key of r+n bits in authenticated encryption, and generating a key component K2 of n bits as a secret value B, the key component K2 being the n bits that remain after the key components K1 is extracted from the secret key;
setting a value generated using a value T that is the key component K1 as a key component of a block cipher, setting the secret value B as an input block of the block cipher, and updating the secret value B using the block cipher; and
executing at least one of a process of encrypting a plaintext M and a process of decrypting a ciphertext C, using the secret value B that has been updated.

16. A non-transitory computer readable medium storing an authenticated encryption program that causes a computer to function as an authenticated encryption device to perform:
an initial process of generating a key component K1 of r bits extracted from a secret key of r+n bits in authenticated encryption, and generating a key component K2 of n bits as a secret value B, the key component K2 being the n bits that remain after the key components K1 is extracted from the secret key;
a function F process of setting a value generated using a value T that is the key component K1 generated by the initial process as a key component of a block cipher, setting the secret value B generated by the initial process as an input block of the block cipher, and updating the secret value B using the block cipher; and
a ciphertext process of executing at least one of a process of encrypting a plaintext M and a process of decrypting a ciphertext C, using the secret value B updated by the function F process.

17. An authenticated encryption method comprising:
generating a secret value B from a secret key in authenticated encryption;
setting the secret value B as an input block of a block cipher, updating the secret value B using the block cipher, setting a secret value B at a certain time point as a secret value B[0], setting a secret value B[i−1] as an input block of a block cipher, and updating the secret value B[i−1] using the block cipher to generate a secret value B[i], for each integer i in ascending order, where i=1, . . . , m; and
executing at least one of a process of encrypting a plaintext M and a process of decrypting a ciphertext C using the secret value B[i] for each integer i, where i=1, . . . , m.

18. A non-transitory computer readable medium storing an authenticated encryption program that causes a computer to function as an authenticated encryption device to perform:
an initial process of generating a secret value B from a secret key in authenticated encryption;
a function F process of setting the secret value B generated by the initial process as an input block of a block cipher, and updating the secret value B using the block cipher, the function F process setting a secret value B at a certain time point as a secret value B[0], setting a secret value B[i−1] as an input block of a block cipher, and updating the secret value B[i−1] using the block cipher to generate a secret value B[i], for each integer i in ascending order, where i=1, . . . , m; and
a ciphertext process of executing at least one of a process of encrypting a plaintext M and a process of decrypting a ciphertext C using the secret value B[i] for each integer i, where i=1, . . . , m, generated by the function F process.
